(19) United States
(12) Patent Application Publication
(10) Pub. No.: US 2003/0012082 A1
(43) Pub. Date: Jan. 16, 2003

(54) Spray can mixer apparatus

(76) Inventor: E. Ray Carter, Phoenix, AZ (US)

Correspondence Address: H. GORDON SHIELDS, 7830 NORTH 23RD AVENUE, PHOENIX, AZ, 85021, US

(21) Appl. No.: 09/903,041

(22) Filed: Jul. 11, 2001

(51) Int. Cl. B01F 11/00

(52) U.S. Cl. 366/213

(57) ABSTRACT

Spray paint can mixer apparatus includes a housing in which is disposed a relatively low speed motor. Extending outwardly from the housing and connected to the motor is a spray paint can holder assembly. The spray paint can holder assembly holds a can of spray paint and rotates in response to rotation of the motor to mix paint within the can. The motor rotates the spray paint can holder assembly and the spray paint can secured thereto at a relatively low RPM so that the mixer ball or element within the spray paint can is able to move freely for the mixing operation. Different embodiments of spray paint can holder assemblies are disclosed.

### BACKGROUND OF THE INVENTION

1. Field of the Invention

This invention relates to apparatus for mixing spray paint cans and, more particularly, to apparatus for rotating spray paint cans to mix the paint within the cans.

2. Description of the Prior Art

U.S. Pat. No. 3,706,443 (Oberhauser) comprises apparatus for mixing a can of paint by agitating the paint can by rapidly rotating the can of paint and by rocking the can of paint at the same time.

U.S. Pat. No. 3,880,408 (Karjalainen) relates to another type of apparatus for mixing paint cans. The apparatus also mixes the cans by movement in two axis.

U.S. Pat. No. 4,445,782 (Sparrow, Jr.) is a belt driven apparatus.

U.S. Pat. No. 4,789,245 (Morbeck) describes apparatus for mixing paint cans by movement in two axis.

U.S. Pat. No. 5,197,802 (Miller et al) describes apparatus for mixing paint cans. Again, paint cans are rotated about two axis.

U.S. Pat. No. 5,261,744 (Brunn) and U.S. Pat. No. 5,383,163 (Brunn) both describe mixing apparatus for paint cans utilizing gyro scopic action. The '163 patent is a continuation of the parent application from which the '744 matured.

U.S. Pat. No. 5,507,575 (Rossetti) describes another type of mixing apparatus which utilizes an oscillating movement.

U.S. Pat. No. 5,711,601 (Thomas et al) describes another type of mixing apparatus in which the mixing apparatus is disposed within a cabinet. An interlock is utilized to stop the mixing movement action when the cabinet door is open.

U.S. Pat. No. 7,788,371 (Neri et al) discloses paint mixing apparatus in which spring elements are used to hold a can in place while the apparatus rotates in two planes.

U.S. Pat. No. 5,904,421 (Mazzalveri) discloses another type of mixing apparatus, the apparatus also includes a cabinet or housing for the mixing elements.

All of the above described patents relate to mixing of large cans, and all of them are relatively complicated. Such apparatus, in general, cannot be used to mix spray paint cans since spray paint cans include a mixing ball or element, and the agitation of the can causes the mixing element to move, and the movement of the mixing element actually mixes the paint.

The apparatus of the present invention is designed specifically for mixing spray paint cans, as opposed to the relatively large cans referred to in the above discussed patents.

### SUMMARY OF THE INVENTION

The invention described and claimed herein includes apparatus for holding a can of spray paint and for rotating the can of spray paint by a motor at a relatively low rpm. The rotational speed of the apparatus is such as to allow the mixing ball or element within the paint can to move freely in order to mix the paint, but the rotational speed is also low enough so that centrifugal force does not hold the mixing ball or element in a particular location.

Among the objects of the present invention are the following:

To provide new and useful apparatus for mixing spray paint;

To provide new and useful apparatus for rotating a spray paint can to mix the paint therein;

To provide new and useful spray paint can mixing apparatus including a housing in which is disposed a motor and the motor is connected to a rotating can holder assembly;

To provide new and useful spray can mixing apparatus having a can holding assembly which rotates at a relatively low rpm; and

To provide new and useful spray paint can mixing apparatus having a can holder assembly which holds cans of various sizes.

### BRIEF DESCRIPTION OF THE DRAWING

FIG. 1 is a perspective view of the apparatus of the present invention.

FIG. 2 is a perspective view of the apparatus of FIG. 1 with elements spaced apart.

FIG. 3 is a side view of an alternate embodiment of a portion of the apparatus of FIGS. 1 and 2.

FIG. 4 is a top view of the apparatus of FIG. 3.

FIG. 5 is a side view of an alternate embodiment of a portion of the apparatus of the present invention.

FIG. 6 is a view in partial section taken generally along line 6-6 of FIG. 5.

FIG. 7 is a side view in partial section of another alternate embodiment of a portion of the apparatus of the present invention.

FIG. 8 is a top view of the apparatus of FIG. 7.

FIG. 9 is a front view of the apparatus of FIGS. 7 and 8.

FIG. 10 is top view in partial section of another alternate embodiment of a portion of the apparatus of the present invention.

FIG. 11 is a top view of another alternate embodiment of a portion of the apparatus of the present invention.

FIG. 12 is a front view of another alternate embodiment of a portion of the present invention.

FIG. 13 is a top view of another alternate embodiment of a portion of the present invention.

FIG. 14 is a perspective view of an alternate embodiment of the apparatus of the present invention with a can of spray paint spaced apart from a clamp holder.

FIG. 15 is a perspective view of a portion of the apparatus of FIG. 14 with a portion of the apparatus spaced apart illustrating the apparatus with the clamp holder adapted to hold a can of spray paint having a different diameter than the can illustrated in FIG. 14.

### DESCRIPTION OF THE PREFERRED EMBODIMENT

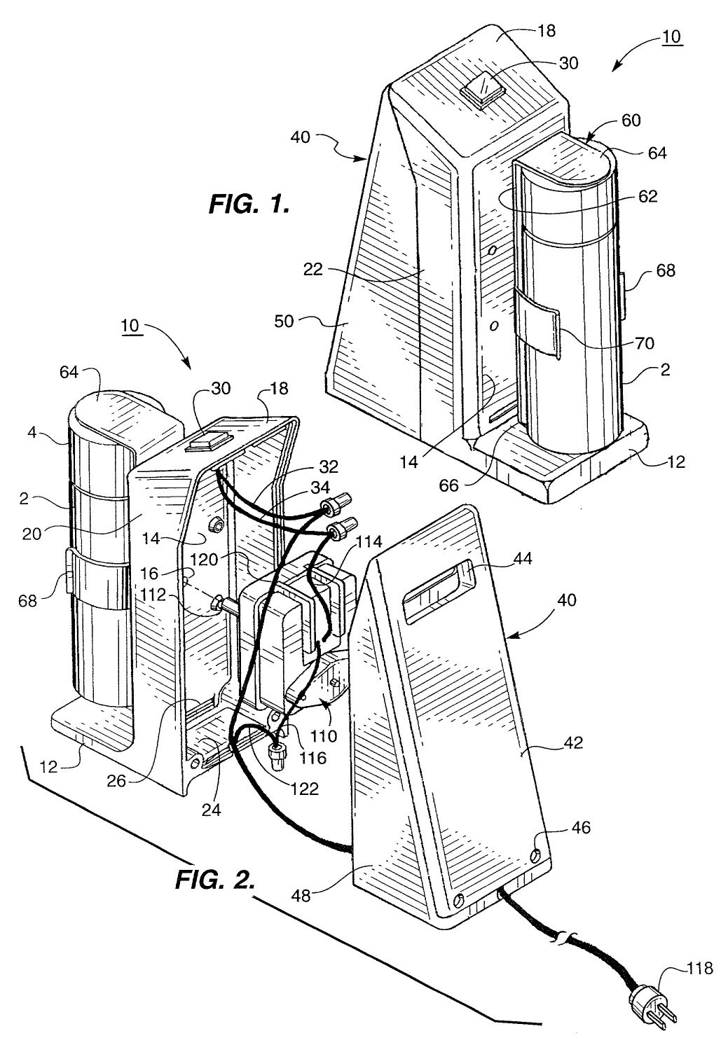

FIG. 1 is a perspective view of spray can mixer apparatus 10 of the present invention. The apparatus includes a base 12, with its various elements and a rear cover 40. FIG. 2 is a perspective view of the apparatus 10 showing the rear cover 40 separated from the base 12 and showing a motor 110. In FIG. 2, the motor 110 is spaced apart from the base 12 and its elements and from the rear cover 40. For the following discussion, reference will be made to both FIGS. 1 and 2.

Extending upwardly from the base 12 is a front panel 14. An aperture 16 extends through the front panel 14, as will be discussed below.

Extending rearwardly from the upper portion of the front panel 14 is a top panel 18. A switch assembly 30 is appropriately secured to the top panel 18. The switch 30 may, fo course, be located as desired, such as on a side panel, or a front panel, etc.

Extending rearwardly from the front panel 14, and extending between the base 12 and the top panel 18 are two side panels, a side panel 20 and a side panel 22. At the lower portion of the panels 20 and 22 and the front panel 14 is a bottom panel 24. Extending through the front panel 14 adjacent to the bottom 24 is an air vent 26. The air vent 26 provides for the movement of air within the housing defined within the rear cover 40 and the base 12, the front panel 14, top panel 18, the side panels 20 and 22, and the bottom panel 24.

The rear cover 40 includes a back panel 42 through which extends an air vent 44. The air vent 44 is adjacent to the top of the rear cover 40. At the lower portion of the back panel 42 are a pair of screw holes 46. The screw holes 46 receive appropriate screw fasteners (not shown) for securing the rear cover 40 to the base 12.

A can holder assembly 60 is shown disposed outwardly from the front panel 14. The can holder assembly 60 includes a back panel 62 and a top panel 64 and bottom panel 66. The top panel 64 and the bottom panel 66 extend outwardly from the back panel. A can 2 is shown disposed between the top and bottom panels 64 and 66. The can 2 is held in place in the can holder assembly 60 by a pair of spring arms 68 and 70. The spring arms 68 and 70 extend forwardly and essentially inwardly from the back panel 62.

The can holder assembly 60 is appropriately secured to a shaft 112 of a motor 110. The motor 110 is secured to the front panel 14 by appropriate fastening means, well known and understood. The shaft 112 extends through the aperture 116 in the front panel 14.

The motor 110 is illustrated as an electric motor, operating on typical household current, provided by a one hundred twenty volt alternating current source. However, the motor may be a battery operated or it may be a spring wound motor Since the motor operates at a relatively low RPM, such as between about thirty five and sixty five RPM, with about fifty RPM preferred, only relatively low power is needed.

Conductors 32 and 34 appropriately connect the switch assembly 30 to both the motor 110 and to a source of electrical current from a plug 118. The plug 118 includes a pair of conductors 120 and 122. Another pair of conductors 114 and 116 are connected to the motor 110. The “hot” conductor 120 from the plug 118 extends to the conductor 32 of the switch 30. The “neutral” conductor 122 from the plug 118 extends to the conductor 116 of the motor 110. The conductor 34 from the switch 30 extends to the conductor 114 of the motor 110. As shown, and as may be understood, appropriate wire connectors are used to secure the respective conductors together.

The motor 110 is preferably a low speed motor, as mentioned above, such that the shaft 112, and accordingly the can holder assembly 60 with the can 2 secured thereto at a suggested rotational rate of about fifty RPM The fifty RPM allows a mixing element within the can 2 to move during rotation in order to mix the paint within the can. If the RPM of the motor 110 were too fast, centrifugal force would cause the mixing element to stay in place and accordingly only limited mixing, if any, would take place. As indicated, a rotational speed of between about thirty five and sixty five RPM is preferred, and fifty RPM appears to work well.

If desired, a timer (not shown) may be installed in association with the switch assembly 30 and the motor 110 such that the motor may be actuated for a specific amount of time and then turn off automatically at the end of the specific time. The timer may be either be a variable timer, set by a user, or it may have a fixed “on” time which, theoretically, would be a sufficient amount of time to allow a complete mixing of the paint within the can 2.

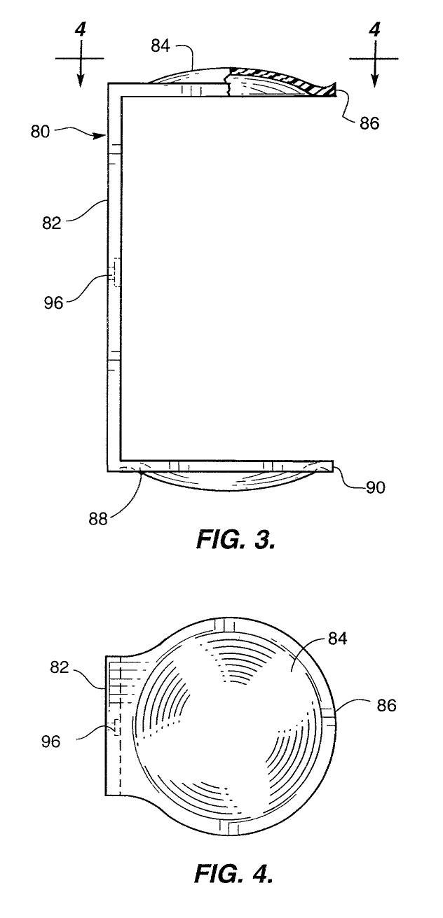

FIGS. 3 and 4 disclose an alternate can holder assembly 80 which may be used in place of the can holder assembly 60 of FIGS. 1 and 2. The difference between the can holder assembly 60 and the can holder assembly 80 is the use of saucer-like upper and lower spring element panels to eliminate the need for the center spring arms to hold a can in the assembly. For the following discussion, reference will primarily made to FIGS. 3 and 4.

The can holder assembly 80 includes back panel 82 and a top panel 84 and a bottom panel 88. The top panel 84 and the bottom panel 88 extend outwardly from the respective top and bottom portions of the back panel 82. The top and bottom panels 84 and 88 have a saucer-like or cup shaped configuration, with outer rims 86 and 90, respectively. The rims 86 and 90 extend towards each other and thus hold a can in position as the assembly 80 rotates. The rims and their panels are sufficiently flexible so that a can may be interposed between them and held there between the two elements securely during the rotational mixing process.

The saucer-like configuration of the panels 84 and 88 may be best understood by reference to the cut away, or partial section, showing of the top panel 84. The diameter of the interior cup configuration is sufficient to hold the spray paint cans inwardly of the rims.

Because of the saucer-like or cup-like configuration of the top and bottom panels, no center clamp, such as shown in FIGS. 1 and 2, is required.

A motor shaft hole or bore 96 extends centrally through the back panel 82. The central location of the hole or bore 96 provides a proper balance to the assembly 80 as it rotates to mix a can of spray paint.

It will be noted that the can holder assemblies 60 and 80 are fixed in the distances between their respective top and bottom panels, and accordingly they may accommodate only a single size spray paint can. There are typically two sizes of cans in usage, namely cans about eight inches tall and cans about nine and one-half inches tall. The difference of one and one-half inches requires compensation in a can holder assembly.

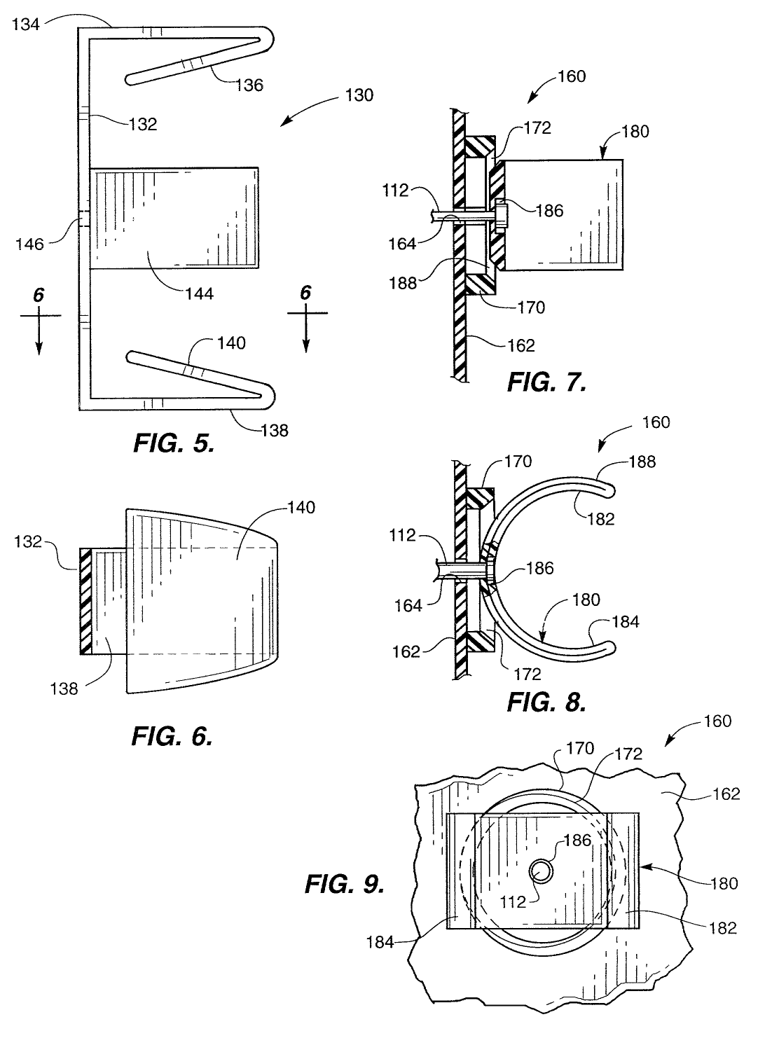

FIG. 5 is a side view of an alternate embodiment can holder assembly 130, which comprises an alternate embodiment of the can holder assembly 80 of FIGS. 3 and 4. FIG. 6 is a view in partial section taken along line 6-6 of FIG. 5. For the following discussion, reference will be made to both FIGS. 5 and 6.

The alternate embodiment can holder assembly 130 includes a back panel 132 to which are secured two panels, a top panel 134 and a bottom panel 138. The panels 134 and 138 extend outwardly from the back panel 132 at substantially right angles. Extending inwardly and downwardly from the outer edge of the top panel 134, remote from the back panel 132, is a spring element 136. A similar spring element 140 extends upwardly and inwardly from the outer edge of the bottom panel 138. The purpose of the spring panels 136 and 140 is, of course, to hold spray cans of various heights. For the shorter cans, as discussed above, the spring elements 136 and 140 provide a necessary inward bias or pressure to secure the paint can between them. For the larger cans, the spring elements 136 and 140 extend respectively upwardly and downwardly until they are disposed about parallel with the panels 134 and 138, respectively.

A pair of spring arms extend outwardly from the back panel 132 at the mid point thereof. Only a single spring arm 144 is shown in FIG. 5. However, the spring arms, of which the spring arm 144 is shown, are substantially the same as illustrated above in FIGS. 1, 2, 3, and 4.

A motor shaft holder aperture 146 extends through the back panel 132 to secure the can holder assembly 130 to the motor shaft 112, as discussed above in conjunction with the embodiment of the apparatus 10 of FIGS. 1 and 2.

FIG. 7 is a side view in partial section of another alternate embodiment of the apparatus of the present invention. FIG. 8 is a top view of the apparatus of FIG. 7, and FIG. 9 is a front view of the apparatus of FIGS. 7 and 8. For the following discussion, reference will be made to FIGS. 7, 8, and 9.

Alternate embodiment 160 replaces the can holder assemblies of FIGS. 1-6 by a single clamp 180. The clamp 180 is secured to a motor shaft 112. The motor shaft 112 extends through an aperture or hole 164 in a housing front panel 162. Disposed concentrically around the hole or aperture 164, and accordingly around the shaft 112, is a cam ring 170. The clamp 180 is disposed adjacent to, and partially within, the cam ring 170.

The clamp 180 includes two arms 182 and 184, which extend outwardly from a central portion. An aperture 186 extends through the central portion. The shaft 112 extends through the aperture 186, and the clamp 180 is appropriately secured to the shaft 112 at the aperture 186.

The purpose of the cam ring 170 is to allow a spray can to be disposed against the ring 170 to cam the can out of the clamp 180. Thus, the ring 170 prevents excess force being applied to the clamp 180 which may cause the clamp to fail. The clamp 180 is, of course, a relatively strong spring clamp, designed generally like the clamps of FIGS. 1 and 2, FIGS. 3 and 4, and FIGS. 5 and 6. However, with a single clamp, the need for the entire can holder assembly is obviated. Accordingly, the clamp 180 may be somewhat stronger than the clamp elements discussed above for the various can holder assemblies. Moreover, the use of only a single clamp obviates elements required to hold cans of different sizes, such as illustrated above in conjunction with FIGS. 3 and 4 and FIGS. 5 and 6, and discussed above.

The inside of the rim of the ring 170 is chamfered to insure clearance with the clamp 180. Reference numeral 172 indicates the chamfered surface on the ring 170. The rear of the clamp 180, adjacent to the aperture or hole 186 is also chamfered, for the same reason. The chamfering on the clamp 180 is indicated by reference numeral 188.

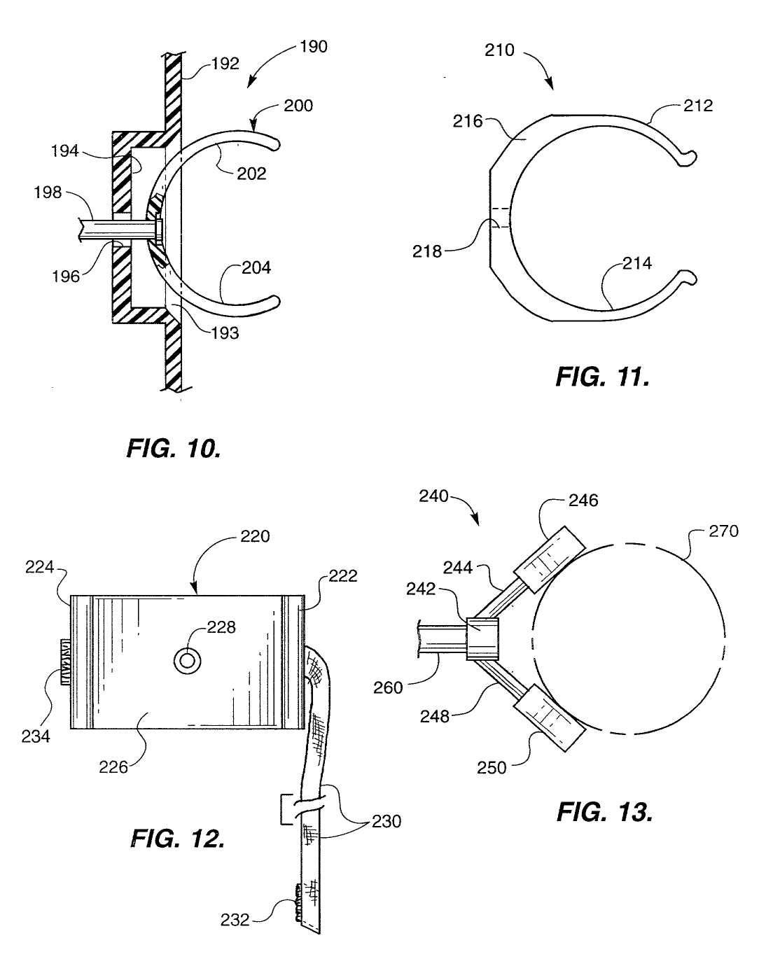

FIG. 10 is a top view in partial section of an alternate embodiment of the assembly 80 of FIGS. 3 and 4, with an alteration or modification in the front panel of a housing. In FIG. 10, an alternate embodiment 190 includes a front panel or wall 192 of a housing, with a recess 194 extending inwardly from the plane of the panel. A motor shaft aperture or bore 196 extends centrally through the recess 194. The recess 194 is circular in configuration and essentially replaces the cam ring 170 of the assembly 160.

A motor shaft 198 extends through the aperture or bore 196 and is secured to a clamp 200. The clamp 200 includes two spring arms 202 and 204. The arms 202 and 204 are substantially identical to the arms 182 and 184 of the clamp 180 of the embodiment 160 of FIGS. 7, 8, and 9.

The outer periphery of the recess 194, or the juncture of the recess 194 and the front panel 192, comprises a cam surface against which a spray paint can may be disposed when removing the can after mixing.

The juncture of the recess 194 and the panel 192 is chamfered for clearance purposes, such as discussed above in conjunction with FIGS. 7, 8, and 9. The chamfered surface is denoted in FIG. 10 by reference numeral 193. The clamp 200 is also chamfered, the same as with the clamp 180.

Another alternate embodiment of a spray can holder assembly is shown in FIG. 11. FIG. 11 comprises a top view of a clamp 210. The clamp 210 includes a spring arm 212 and a spring arm 214, both of which are secured to, and extend outwardly from, a back panel or portion 216. The back portion 216 is relatively inflexible, while the two spring arms 212 and 214 are relatively flexible in their ability to cam outwardly to allow a can to be inserted between them, and then to spring back to hold the can tightly and securely while th clamp 210 is rotated to mix the paint in the can.

The back portion 216 includes a central aperture or bore 218 for receiving a motor shaft.

The clamp 210, like the assembly 160, allows a can of any size to be rotated without end panels and related elements, such as in the embodiment 130 of FIGS. 5 and 6.

Another alternate assembly is shown in FIG. 12. FIG. 12 comprises a front view of an alternate embodiment clamp assembly 220. The clamp assembly 220 includes a yoke arm 222 and a yoke arm 224, spaced apart from each other, and both are secured to a back plate or panel 226. The yoke arms 222 and 224 are appropriately curved, such as illustrated for the arms of the embodiments of FIGS. 7, 8, 9, and FIG. 11. However, the arms 222 and 224 are relatively inflexible, just as the back panel or plate 226 is relatively inflexible.

A motor shaft aperture or bore 228 extends through the back panel 226. The bore or aperture 228 is centrally located with respect to the panel 226.

To secure a paint can to the assembly 220, a strap 230 is secured to the arm 222. At the outer inside portion of the strap 230, remote from the arm 222, are fastening elements 232. The fastening elements 232 cooperate with fastening elements 234 which are secured to the arm 224. The fastening elements 232 and 234 may be hook and loop type elements, or any appropriate elements.

Thus, a spray paint can is placed within the clamp 220, within the arms 222 and 224, and the strap 230 is fastened around the can to hold the can in place.

The strap 230 may be replaced by an elastic strap, if desired. Obviously, the use of such an element, or other appropriate strap element, requires fastening means that are appropriate for the strap.

FIG. 13 is a top view of still another alternate spray can holder assembly, comprising a holder assembly 240. The can holder assembly 240 includes a central yoke or collar 242 that is secured directly to a motor shaft 260. Extending outwardly from the central yoke or collar 240 are two arms 244 and 248. Secured to the arm 244 is a magnet 246, and secured to the arm 248 is a magnet 250. A spray paint can 270 is held in place by the magnets 246 and 250.

The magnets 246 and 250 may be appropriately configured on their interior sides so as to fit comfortably and securely to the cylindrical or curved outer configuration of the spray paint can 270. The can 270 is accordingly held securely by the magnets 246 and 250 as the shaft 260 rotates to mix the paint in the can.

In place of magnets, as shown in FIG. 13, a suction cup may be secured to the yoke or collar 242. The suction cup would, of course, be configured for the curvature of a paint can, and would have to be relatively strong, just as the magnets 246 and 250 are relatively strong. However, the relatively low RPM at which the shaft 260 rotates makes the feasibility of such alternate holding elements not entirely impractical.

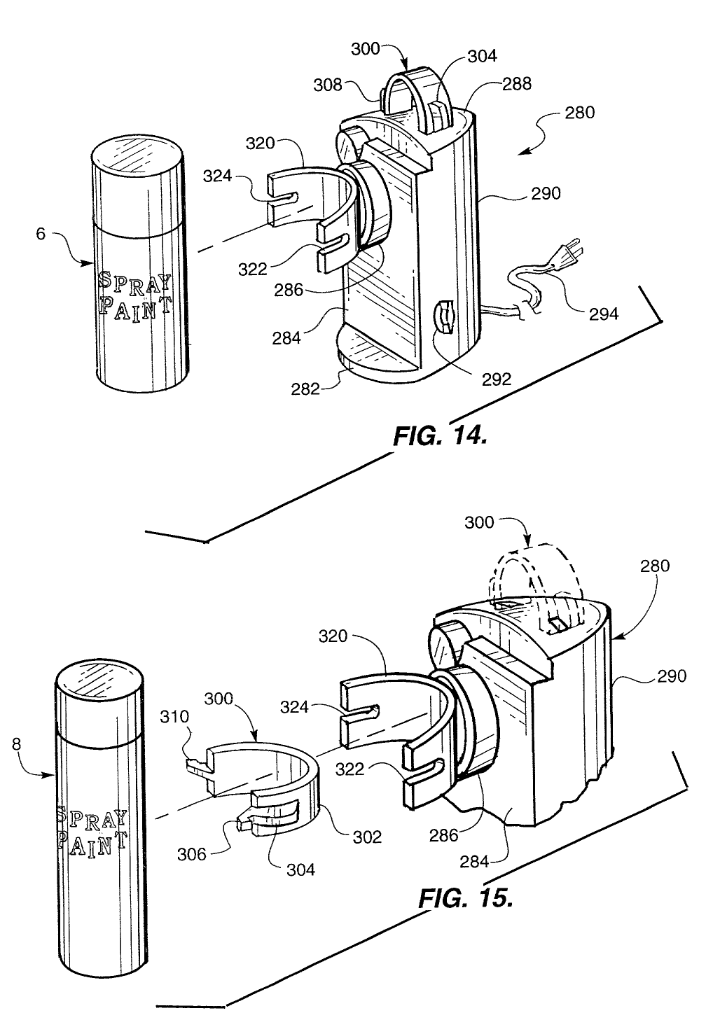

FIG. 14 is a perspective view of an alternate embodiment spray paint can mixing apparatus 280 which includes a can holding assembly for holding spray paint cans having different diameters. FIG. 15 is a perspective view of a portion of the apparatus 280 of FIG. 14 illustrating can holding structure for holding spray paint cans of different diameters. In the previous embodiments, structure for holding spray paint cans of different lengths has been discussed and is shown in drawing figures. In FIGS. 14 and 15 there is illustrated structure for holding spray paint cans by adapting a handle to fit a clamp, with the clamp being sized to hold spray paint cans of one diameter, such as shown in the previous embodiments, and a handle adapter being fitted or secured to the clamp to hold spray paint cans of a smaller diameter than the can held by the clamp without the handle adapter. For the following discussion, reference will primarily be made to FIGS. 14 and 15.

The apparatus 280 includes a base 282, with a front panel 284 extending upwardly from the base 282. Secured to the front panel is a ring 286. The purpose of the ring 286 is substantially the same as the rings discussed in conjunction with the embodiments of FIGS. 7, 8, and 9, etc. A clamp 320 is secured to the shaft (not shown) of a motor (again not shown) secured to the front panel 284. The clamp 320 includes a pair of slots 322 and 324 which extend inwardly from the outer ends of the clamp.

Extending generally upwardly from the base 282 and curved around from one side of the front panel 284 to the other side of the front panel is a founded or curved side 290. At the upper portion of the apparatus 280 is a top 288. On the top 288 is a removable handle 300. The removable handle may best be understood from FIG. 15.

The handle 300 includes a curved portion 302 and a pair of arms 304 and 308. At the outer ends of the arms 302 and 308, and extending outwardly therefrom, are hooks 306 and 310, respectively. The arms and hooks extend into slots on the top 288 to secure the handle 300 to the top 288. The handle is somewhat flexible such that inward pressure on the handle at the arms moves the hooks out of engagement with the top 288 and frees the hooks and the arms from the slots in the top 288, thus freeing the handle 300 from the top.

The handle 300 is then secured to the clamp 320 by inserting the arms 304 and 308 in the slots 322 and 324 of the clamp 320. The hooks 306 and 310 provide the latching securement to secure the top 300 to the clamp 320. The clamp 300 then becomes an adapter for the clamp to hold a spray paint can 8. In FIG. 14, a spray paint can 6 is shown spaced apart from the clamp 320. The spray paint can 6 has what may be referred to as a first diameter, which may be a “standard” diameter, while the spray paint can 8 has a lesser, or second, diameter. The handle adapter 300 thus allows the apparatus 280 to hold spray paint cans of two different diameters. With a clamp type holder element, as opposed to the can holder assemblies having top and bottom panels, and as discussed above for the embodiments having the clamp elements, the length of a spray paint can is generally immaterial.

The handle 300 thus performs two functions, serving as a handle element to carry the apparatus 280, and serving as an adapter for clamping spray paint cans of a smaller or lesser diameter to the apparatus 280 than may be secured to the apparatus by only the clamp 320.

While the apparatus 280 is shown including a ring 286 adjacent to the clamp 320, the reinforced straight backed clamp 210 of FIG. 11 may be used instead of the ring 286 and the clamp 320. In such case, the clamp for the apparatus 280 would include the slots, such as the slots 322 and 324. The reinforced straight backed clamp, with its slots to receive the handle/adapter 300, would generally eliminate the need for the ring 286.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, within the limits only of the true spirit and scope of the invention.

What I claim is:

1. Spray paint can mixer apparatus comprising in combination:
a base;
a panel extending upwardly from the base;
means for holding a spray paint can for mixing; and
a motor connected to the panel and to the means for holding a spray paint can for rotating the means for holding a spray paint can for mixing the paint in the spray paint can at a relatively low RPM.

2. The apparatus of claim 1 which further includes a housing secured to the base for enclosing the motor, and the panel is part of the housing.

3. The apparatus of claim 2 in which the means for holding a spray paint can includes means for holding spray paint cans of different lengths.

4. The apparatus of claim 3 in which the means for holding a spray paint can includes a clamp.

5. The apparatus of claim 4 which further includes a ring adjacent to the clamp and secured to the panel secured to the base.

6. The apparatus of claim 4 which further includes a recess in the panel adjacent to the clamp.

7. The apparatus of claim 4 in which the means for holding a spray paint can further includes a back panel and a top panel and a bottom panel.

8. The apparatus of claim 7 which further includes spring elements on the top and bottom panels for holding spray paint cans of different lengths.

9. Apparatus for mixing paint in a spray paint can comprising in combination;
means for holding the can of spray paint;
a motor connected to the means for holding the spray paint can for rotating the spray paint can at a relatively low RPM; and
means for supporting the means for holding the spray paint can and the motor.

10. The apparatus of claim 9 in which the means for supporting the means for holding a spray paint can and the motor includes a base, and a panel extending upwardly from the base for supporting the motor.

11. The apparatus of claim 10 in which the means for holding the spray paint can includes a clamp secured to the motor.

12. The apparatus of claim 11 which further includes a ring secured to the panel and disposed adjacent to the clamp.

13. The apparatus of claim 11 which further includes a circular recess in the panel adjacent to the clamp.

14. The apparatus of claim 10 in which the means for holding the spray paint can includes platform means rotatably secured to the motor.

15. The apparatus of claim 14 in which the platform means includes
a back panel,
a bottom panel secured to the back panel and extending outwardly from the back panel,
a top panel secured to the back panel remote from the bottom panel, and
the spray paint can is disposed between the bottom and top panels.

16. The apparatus of claim 15 in which the platform means further includes clamp elements secured to the back panel between the bottom and top panels for holding the spray paint can.

17. The apparatus of claim 16 in which the platform means further includes spring elements connected to the bottom and top panels for holding spray paint cans of different lengths.

18. The apparatus of claim 15 in which the platform means further includes a first spring element secured to the bottom panel for holding spray paint cans of different lengths.

19. The apparatus of claim 18 in which the platform means further includes a second spring element secured to the top panel for holding spray paint cans of different lengths.

20. The apparatus of claim 19 in which the first and second spring elements extend towards each other to hold spray paint cans of one length and retract to their respective bottom and top panels to hold spray paint cans of another length.

21. The apparatus of claim 10 which further includes a housing secured to the base for enclosing the motor.

22. The apparatus of claim 21 in which the motor includes a shaft connected to the means for holding the spray paint can, and the shaft rotates between about thirty five and sixty five revolutions per minute.

23. The apparatus of claim 22 in which the motor is an electric motor.

24. The apparatus of claim 9 in which the means for holding the spray paint can includes element means secured to the motor and having a first area and a second area.

25. The apparatus of claim 24 in which the element means includes a first arm and a second ann.

26. The apparatus of claim 24 in which the first and second arms of the element means are spring arms.

27. The apparatus of claim 24 in which the first and second arms are fixed, and the element means further includes a strap for securing the spray paint can to the first and second arms.

28. The apparatus of claim 24 in which the first and second arms are fixed, and the element means further includes a first magnet secured to the first arm and a second magnet secured to the second arm for securing the spray paint can to the first and second arms.

29. The apparatus of claim 11 in which the means for supporting the means for holding a spray paint can and the motor includes a top secured to the panel, and a handle is secured to the top.

30. The apparatus of claim 29 in which the handle is removably secured to the top.

31. The apparatus of claim 30 in which the clamp includes a pair of slots, and the handle includes a pair of flanges which extend into the pair of slots when the handle is disposed against the clamp.

32. The apparatus of claim 9 in which the means for supporting the means for holding the spray paint can and the motor includes a housing and a handle secured to the housing.

33. The apparatus of claim 32 in which the means for holding a spray paint can includes a clamp for holding a spray paint can having a first diameter.

34. The apparatus of claim 33 in which the handle is removable from the housing and securable to the clamp for holding a spray paint can having a second diameter.

35. The apparatus of claim 34 in which the clamp includes a pair of slots and the handle includes a pair of arm elements which extend in to the pair of slots in the clamp to secure the handle to the clamp.

36. The apparatus of claim 35 in which the housing includes
a base,
a front panel extending generally upwardly from the base for supporting the motor, and
a ring secured to the front panel adjacent to the clamp.
